(19) United States
(12) Patent Application Publication
(10) Pub. No.: US 2009/0159660 A1
(43) Pub. Date: Jun. 25, 2009

(54) Document diverter apparatus for use in a check processing module of a self-service check depositing terminal

(75) Inventors: Fredrik L.N. Kallin, Waterloo (CA); Robert J. Ross, Waterloo (CA)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 12/004,354

(22) Filed: Dec. 20, 2007

(51) Int. Cl. B65H 29/58; G07D 11/00; G07F 19/00

(52) U.S. Cl. 235/379

(57) ABSTRACT

A document diverter apparatus is provided for use in a check processing module (CPM) of a self-service check depositing terminal. The apparatus comprises a first member which can be (i) moved between a first position and a second position when the CPM is configured to operate in a first mode of operation, (ii) moved between the second position and a third position when the CPM is configured to operate in a second mode of operation, and (iii) constrained to be in the second position when the CPM is configured to operate in a third mode of operation. The apparatus further comprises a second member which can be (i) disposed in a first position to configure the CPM to be operate in the first mode of operation, (ii) disposed in a second position to configure the CPM to be operate in the second mode of operation, and (iii) disposed in a third position to configure the CPM to be operate in the third mode of operation. The first member may comprise a diverter blade having a plurality of fingers. The second member may comprise a detent arm which can be disposed in any one of the first, second, and third positions of the detent arm to configure the CPM in the first, second, and third modes of operation, respectively. The apparatus may further comprise an actuatable solenoid for (i) moving the first member from the second position to the first position when the solenoid is actuated and the second member is disposed in the first position, and (ii) moving the first member from the second position to the third position when the solenoid is actuated and the second member is disposed in the second position.

### BACKGROUND

The present invention relates to self-service check depositing terminals, and is particularly directed to a document diverter apparatus for use in check processing module of a self-service check depositing terminal, such as a check depositing automated teller machine (ATM).

In a typical check depositing ATM, an ATM customer is allowed to deposit a check (without having to place the check in any deposit envelope) in a publicly accessible, unattended environment. To deposit a check, the ATM customer inserts a user identification card through a user card slot at the ATM, enters the amount of the check being deposited, and inserts the check to be deposited through a check slot of a check acceptor. A check transport mechanism receives the inserted check and transports the check in a forward direction along a check transport path to a number of locations within the ATM to process the check.

If the check is not accepted for deposit, the check transport mechanism transports the check in a reverse direction along the check transport path to return the check to the ATM customer via the check slot. If the check is accepted for deposit, the amount of the check is deposited into the ATM customer's account and the check is transported to a storage bin within the ATM. An endorser printer prints an endorsement onto the check as the check is being transported to and stored in the storage bin. Checks in the storage bin within the ATM are periodically picked up and physically transported via courier to a back office facility of a financial institution for further processing.

In some known check depositing ATMs, certain components are housed in modular units which, in turn, are housed in a larger module. The larger module is sometimes referred to as a “check processing module” (CPM). Such modules are included in ATMs provided by NCR Corporation, located in Dayton, Ohio. One example is Model No. CPM2 in which a modular unit called a “pocket module” is located in approximately the central portion of the CPM. Another example is Model No. CPM3 in which the pocket module is located in approximately the bottom portion of the CPM. Still another example is Model No. CPM4 in which the pocket module is located in approximately the top portion of the CPM. It would be desirable to provide a single CPM which contains components which can be configured to provide functionality of the CPM2, the CPM3, and the CPM4.

### SUMMARY

In accordance with an embodiment of the present invention, a document diverter apparatus is provided for use in a check processing module (CPM) of a self-service check depositing terminal. The apparatus comprises a first member which can be (i) moved between a first position and a second position when the CPM is configured to operate in a first mode of operation, (ii) moved between the second position and a third position when the CPM is configured to operate in a second mode of operation, and (iii) constrained to be in the second position when the CPM is configured to operate in a third mode of operation. The apparatus further comprises a second member which can be (i) disposed in a first position to configure the CPM to be operate in the first mode of operation, (ii) disposed in a second position to configure the CPM to be operate in the second mode of operation, and (iii) disposed in a third position to configure the CPM to be operate in the third mode of operation. The first member may comprise a diverter blade having a plurality of fingers. The second member may comprise a detent arm which can be disposed in any one of the first, second, and third positions of the detent arm to configure the CPM in the first, second, and third modes of operation, respectively. The apparatus may further comprise an actuatable solenoid for (i) moving the first member from the second position to the first position when the solenoid is actuated and the second member is disposed in the first position, and (ii) moving the first member from the second position to the third position when the solenoid is actuated and the second member is disposed in the second position.

### BRIEF DESCRIPTION OF THE DRAWINGS

In the accompanying drawings:

FIG. 1 is a left-front perspective view of one type of check depositing automated teller machine (ATM) embodying the present invention;

FIG. 2 is a simplified schematic diagram, looking approximately in the direction of arrow X in FIG. 1, and illustrating a scaleable check processing module (SCPM) configured to operate in the ATM of FIG. 1;

FIG. 3 is diagram similar to the diagram of FIG. 2, and illustrating the SCPM configured to operate in another type of ATM;

FIG. 4 is diagram similar to the diagrams of FIGS. 2 and 3, and illustrating the SCPM configured to operate in yet another type of ATM;

FIG. 5 is a pictorial view of a transport module of the SCPM of FIG. 2;

FIG. 6 is a pictorial view of a diverter used in the transport module of FIG. 5;

FIG. 7 is a view similar to the view of FIG. 5, and showing an end plate portion removed to better illustrate the diverter of FIG. 6;

FIG. 8 is an elevational view, looking approximately in the direction of arrow Y shown in FIG. 7, and illustrating position of the diverter in a home position when the SCPM is configured to operate as shown in FIG. 2;

FIG. 9 is an elevational view, looking approximately in the direction of arrow Z shown in FIG. 7, and illustrating position of parts of an actuator mechanism for the diverter in the home position of FIG. 8 when the SCPM is configured to operate as shown in FIG. 2;

FIG. 10 view similar to FIG. 8, and illustrating position of the diverter when a solenoid in the actuator mechanism of FIG. 9 is actuated;

FIG. 11 is view similar to FIG. 9, and illustrating position of parts of the actuator mechanism when a solenoid in the actuator mechanism is actuated;

FIG. 12 is a view similar to the view of FIG. 10, and illustrating position of the diverter when the SCPM is configured to operate as shown in FIG. 3 and the solenoid is actuated;

FIG. 13 is a view similar to the view of FIG. 11, and illustrating position of parts of the actuator mechanism when the SCPM is configured to operate as shown in FIG. 3 and the solenoid is actuated;

FIG. 14 is a view similar to the view of FIG. 10, and illustrating position of the diverter when the SCPM is configured to operate as shown in FIG. 4 and the solenoid is actuated; and

FIG. 15 is a view similar to the view of FIG. 11, and illustrating position of parts of the actuator mechanism when the SCPM is configured to operate as shown in FIG. 4 and the solenoid is actuated.

### DETAILED DESCRIPTION

The present invention is directed to a document diverter apparatus for use in a check processing module of a self-service terminal, such as a check depositing automated teller machine (ATM).

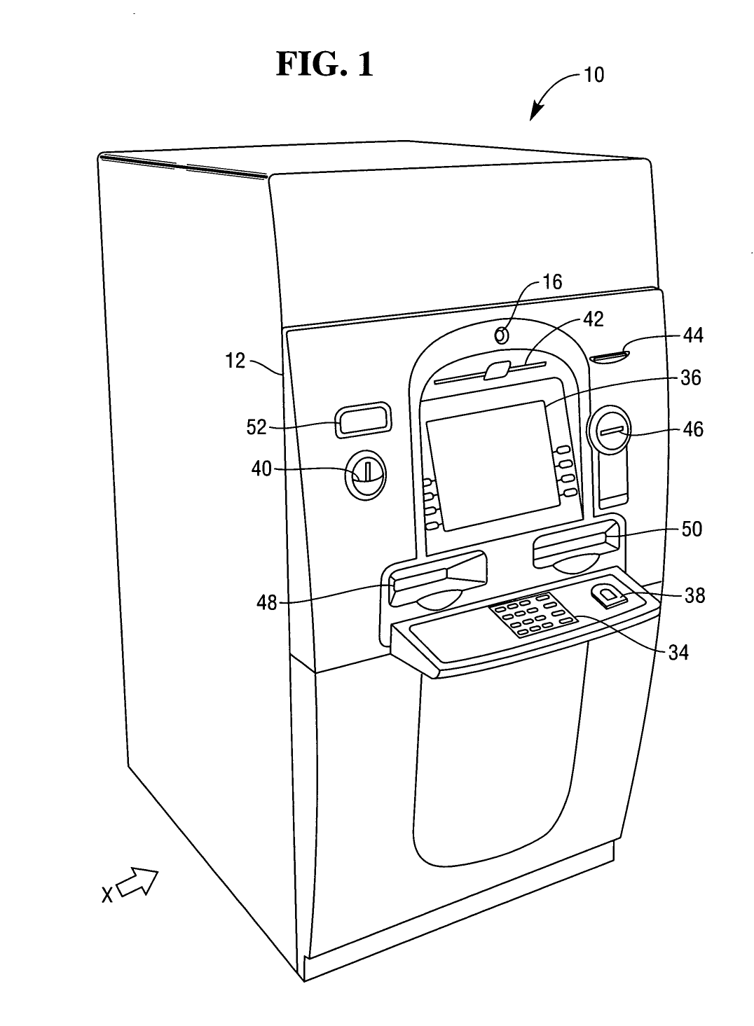

Referring to FIG. 1, a self-service check depositing terminal in the form of an image-based check depositing automated teller machine (ATM) 10 is illustrated. The check depositing ATM 10 comprises a fascia 12 coupled to a chassis (not shown). The fascia 12 defines an aperture 16 through which a camera (not shown) images a customer of the ATM 10. The fascia 12 also defines a number of slots for receiving and dispensing media items, and a tray 40 into which coins can be dispensed. The slots include a statement output slot 42, a receipt slot 44, a card reader slot 46, a cash slot 48, another cash slot 50, and a check input/output slot 52. The slots 42 to 52 and tray 40 are arranged such that the slots and tray align with corresponding ATM modules mounted within the chassis of the ATM 10.

The fascia 12 provides a user interface for allowing an ATM customer to execute a transaction. The fascia 12 includes an encrypting keyboard 34 for allowing an ATM customer to enter transaction details. A display 36 is provided for presenting screens to an ATM customer. A fingerprint reader 38 is provided for reading a fingerprint of an ATM customer to identify the ATM customer. The user interface features described above are all provided on an NCR PERSONAS (trademark) 6676 ATM, available from NCR Financial Solutions Group Limited, Discovery Centre, 3 Fulton Road, Dundee, DD2 4SW, Scotland.

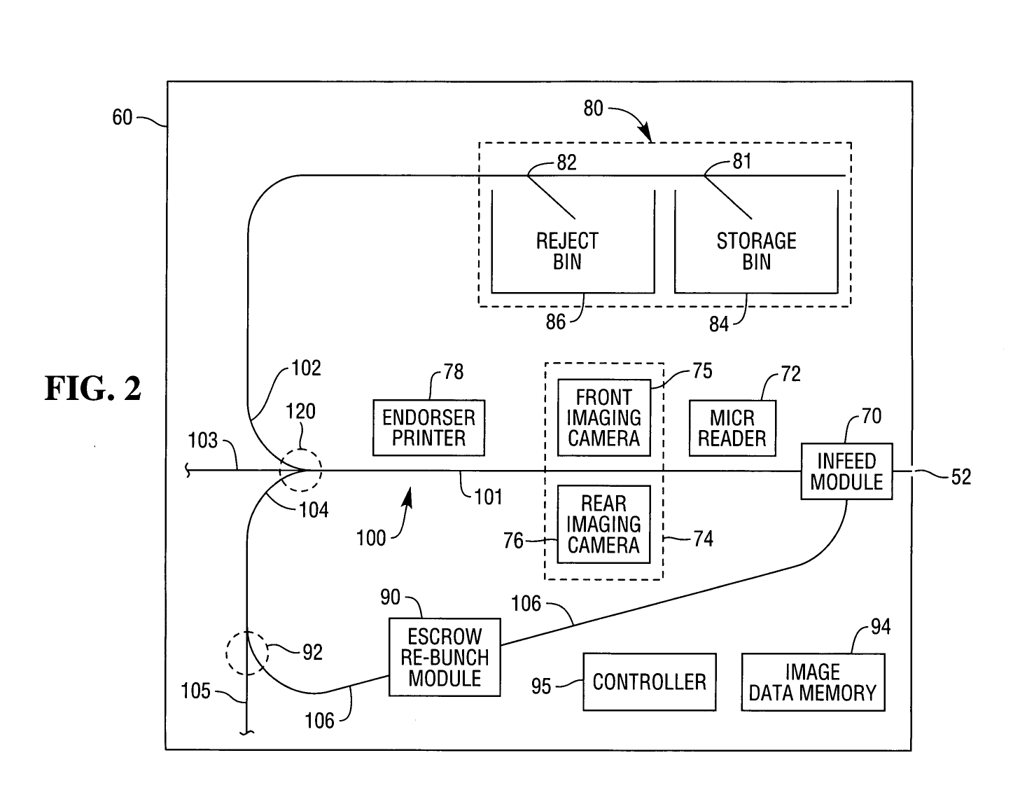

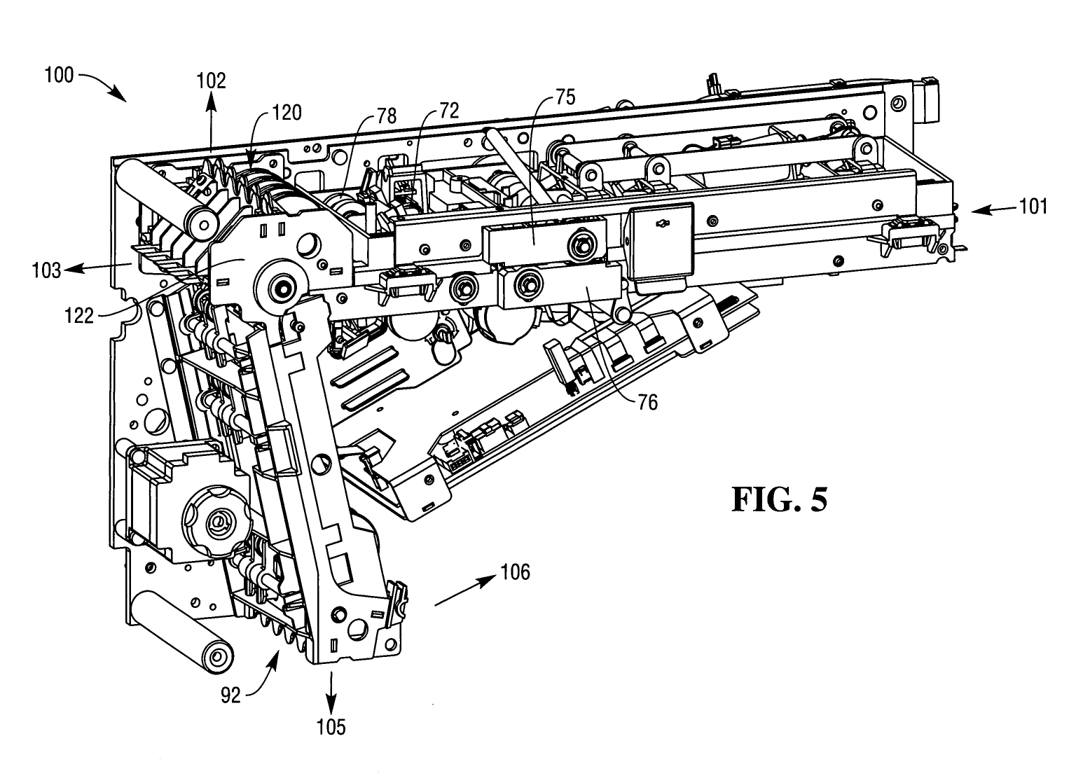

Referring to FIG. 2, a first configuration of a scaleable check processing module (SCPM) 60 is illustrated. The SCPM 60 will now be described with reference to FIGS. 2 and 5. FIG. 2 is a simplified schematic diagram (looking approximately in the direction of arrow X in FIG. 1) of part of the fascia 12 and main parts of the SCPM 60. FIG. 5 is a pictorial view of a part (to be described later) used in the SCPM 60 shown in FIG. 2.

The SCPM 60 of FIG. 2 comprises four main units which include an infeed module 70, a pocket module 80, an escrow re-bunch module (ERBM) 90, and a transport module 100. The infeed module 70 receives a check which has been deposited into the check input/output slot 52 (FIG. 1), and transports the check to an inlet of the transport module 100. The dimensions of the infeed module 70, such as its run length, may vary depending upon the particular model ATM the SCPM 60 is installed. The structure and operation of the infeed module 70 are conventional and well known and, therefore, will not be described.

The transport module 100 includes a check input/output transport mechanism which receives a check from the inlet adjacent to the infeed module 70, and transports the check along a first document track portion 101 which is the main track portion. The transport module 100 includes a first document diverter 120 which is operable to divert a check along a second document track portion 102 to the pocket module 80, a third document track portion 103 (not used in the configuration shown in FIG. 2), or a fourth document track portion 104 which leads to the ERBM 90.

A second document diverter 92 is operable to divert a check along a fifth document track portion 105 (not used in the configuration shown in FIG. 2), or a sixth document track portion 106 which leads to the ERBM 90 and then back to the infeed module 70. More specifically, the sixth document track 106 interconnecting the ERBM 90 and the infeed module 70 allows a bunch of checks which has accumulated in the ERBM to be transported back to the infeed module 70. The structure and operation of the second diverter 92 are conventional and well known and, therefore, will not be described.

The transport module 100 further includes a magnetic ink character recognition (MICR) head 72 for reading magnetic details on a code line of a check. The transport module 100 also includes an imager 74 including a front imaging camera 75 and a rear imaging camera 76 for capturing an image of each side of a check (front and rear). An endorser printer 78 is provided for printing endorsements onto checks. An image data memory 94 is provided for storing images of checks. A controller 95 is provided for controlling the operation of the elements within the SCPM 60.

The pocket module 80 includes a storage bin 84 for storing processed checks. The pocket module 80 further includes a reject bin 86 for storing rejected checks. Two divert gates 81, 82 are provided for diverting checks to either the storage bin 84 or the reject bin 85. The structure and operation of the pocket module 80 are conventional and well known and, therefore, will not be described.

It should be apparent that the SCPM 60 of FIG. 2 is shown in a first configuration where a pocket module is located in a top portion of the SCPM. Accordingly, components of the SCPM 60 of FIG. 2 are configured in a first mode of operation to provide functionality of the Model CPM4 check processing module sold by NCR Corporation.

The SCPM 60 may be of a type which processes a bunch of checks or only one check at a time. This type of processing is sometimes referred to as “multiple-check processing”. If the SCPM 60 is of the type which can process a bunch of checks, then an escrow module (such as the ERBM 90 shown in FIG. 2) is needed. The ERBM 90 is manufactured and available from Glory Products, located in Himeji, Japan. The ERBM 90 allows a bunch of checks (i.e., more than one check) to be processed in a single transaction. If a bunch of checks has accumulated in the ERBM 90 and is unable to be processed further within the SCPM 60, then the bunch of checks is transported via the sixth document track portion 106 back to the infeed module 70 to return the bunch of checks to the ATM customer.

However, if the SCPM 60 is of the type which can process only a single check, then the ERBM 90 is not needed. Once a check is received for processing, the check must be deposited into a bin (i.e., either the storage bin 84 or the reject bin 86) before another check can be received for processing. This type of processing is sometimes referred to as “single-check processing”.

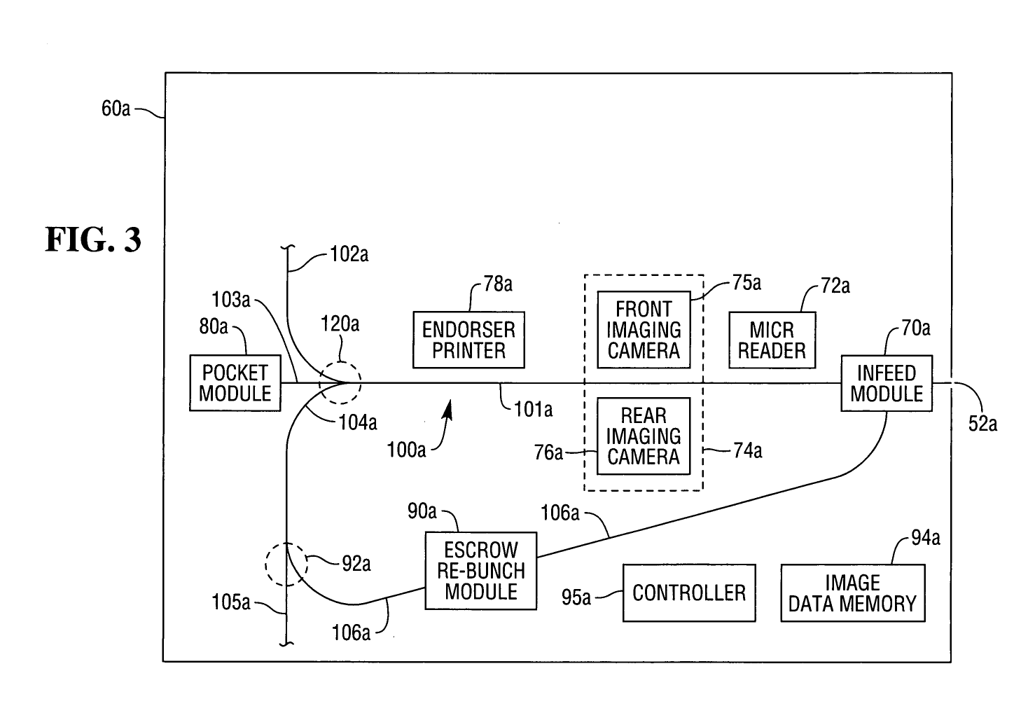

Referring to FIG. 3, a second configuration of the SCPM 60 of FIG. 2 is illustrated. Since the configuration illustrated in FIG. 3 is generally similar to the configuration illustrated in FIG. 2, similar numerals are utilized to designate similar components, the suffix letter “a” being associated with the configuration of FIG. 3 to avoid confusion.

The SCPM 60a shown in FIG. 3 is in a configuration where the pocket module 80a is located in a rear portion of the SCPM. Accordingly, components of the SCPM 60a shown in FIG. 3 are configured in a second mode of operation to provide functionality of the Model CPM2 check processing module sold by NCR Corporation.

The SCPM 60a shown in FIG. 3 comprises four main units which include the infeed module 70a, the pocket module 80a, the ERBM 90a, and the transport module 100a. The infeed module 70a receives a check which has been deposited into the check input/output slot 52a, and transports the check to an inlet of the transport module 100a. The dimensions of the infeed module 70a, such as its run length, may vary depending upon the particular model ATM the CPM 60 is installed. The structure and operation of the infeed module 70a are conventional and well known and, therefore, will not be described.

The transport module 100a includes a check input/output transport mechanism which receives a check from the inlet adjacent to the infeed module 70a, and transports the check along the first document track portion 101a which is the main track portion. The transport module 100a includes the first document diverter 120a which is operable to divert a check along the second document track portion 102a (not used in the configuration shown in FIG. 3), the third document track portion 103a to the pocket module 80a, or the fourth document track portion 104a which leads to the ERBM 90a.

The second document diverter 92a is operable to divert a check along the fifth document track portion 105a (not used in the configuration shown in FIG. 3), or the sixth document track portion 106a which leads to the ERBM 90a and then back to the infeed module 70a. More specifically, the sixth document track 106a interconnecting the ERBM 90a and the infeed module 70a allows a bunch of checks which has accumulated in the ERBM 90a to be transported from the ERBM back to the infeed module 70a. The structure and operation of the second diverter 92a are conventional and well known and, therefore, will not be described.

The transport module 100a further includes a magnetic ink character recognition (MICR) head 72a for reading magnetic details on a code line of a check. The transport module 100a also includes an imager 74a including a front imaging camera 75a and a rear imaging camera 76a for capturing an image of each side of a check (front and rear). An endorser printer 78a is provided for printing endorsements onto checks. An image data memory 94a is provided for storing images of checks. A controller 95a is provided for controlling the operation of the elements within the SCPM 60a.

It should be apparent that the SCPM 60a of FIG. 3 is shown in a second configuration where a pocket module (designated with reference numeral “80a ” in FIG. 3) is located in a central portion of the SCPM. Accordingly, components of the SCPM 60a of FIG. 3 are configured in a second mode of operation to provide functionality of the Model CPM2 check processing module sold by NCR Corporation.

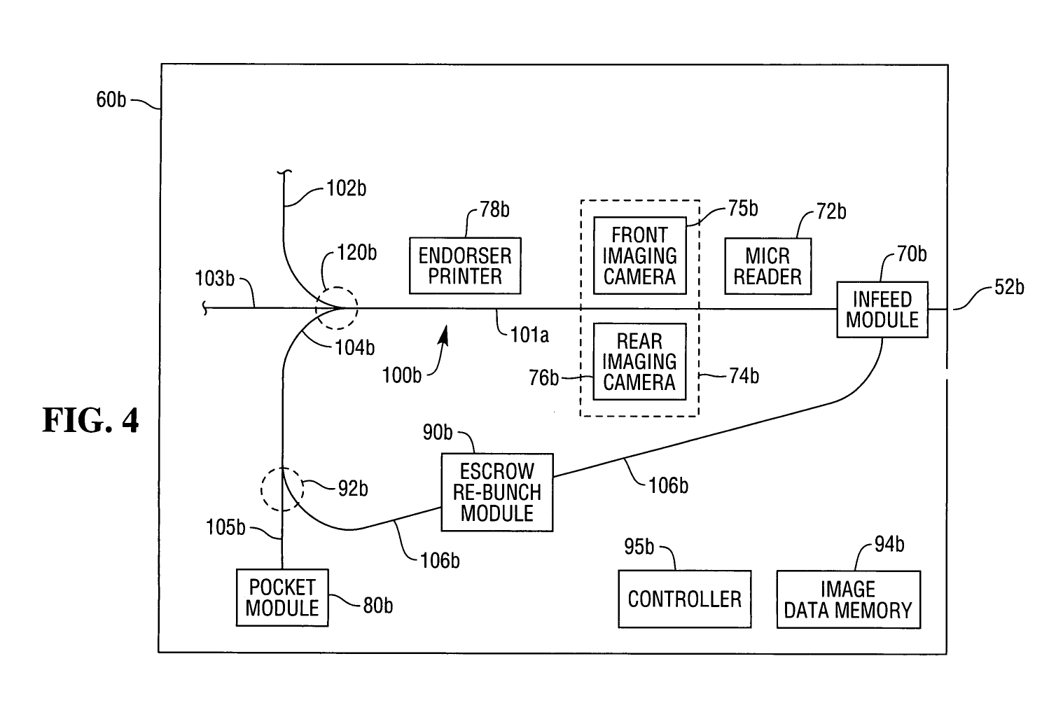

Referring to FIG. 4, a third configuration of the SCPM 60 of FIG. 2 is illustrated. Since the configuration illustrated in FIG. 4 is generally similar to the configuration illustrated in FIG. 2, similar numerals are utilized to designate similar components, the suffix letter “b” being associated with the configuration of FIG. 4 to avoid confusion.

The SCPM 60b shown in FIG. 4 is in a configuration where the pocket module 80b is located in a bottom portion of the SCPM. Accordingly, components of the SCPM 60b shown in FIG. 4 are configured in a third mode of operation to provide functionality of the Model CPM3 check processing module sold by NCR Corporation.

The SCPM 60b shown in FIG. 4 comprises four main units which include the infeed module 70b, the pocket module 80b, the ERBM 90b, and the transport module 100b. The infeed module 70b receives a check which has been deposited into the check input/output slot 52b, and transports the check to an inlet of the transport module 100b. The dimensions of the infeed module 70b, such as its run length, may vary depending upon the particular model ATM the SCPM 60b is installed. The structure and operation of the infeed module 70b are conventional and well known and, therefore, will not be described.

The transport module 100b includes a check input/output transport mechanism which receives a check from the inlet adjacent to the infeed module 70b, and transports the check along the first document track portion 101b which is the main track portion. The transport module 100b includes the first document diverter 120b which is operable to divert a check along the second document track portion 102b (not used in the configuration shown in FIG. 4), the third document track portion 103b (also not used in the configuration shown in FIG. 4), or the fourth document track portion 104b which leads to either the pocket module 80b or the ERBM 90b.

More specifically, the second document diverter 92b is operable to divert a check along either the fifth document track portion 105b which leads to the pocket module 80b or the sixth document track portion 106b which leads to the ERBM 90b and then back to the infeed module 70b. The sixth document track 106b interconnecting the ERBM 90b and the infeed module 70b allows a bunch of checks which has accumulated in the ERBM 90b to be transported from the ERBM back to the infeed module 70b. The structure and operation of the second diverter 92b are conventional and well known and, therefore, will not be described.

The transport module 100b further includes a magnetic ink character recognition (MICR) head 72b for reading magnetic details on a code line of a check. The transport module 100b also includes an imager 74b including a front imaging camera 75b and a rear imaging camera 76b for capturing an image of each side of a check (front and rear). An endorser printer 78b is provided for printing endorsements onto checks. An image data memory 94b is provided for storing images of checks. A controller 95b is provided for controlling the operation of the elements within the SCPM 60b.

It should be apparent that the SCPM 60b of FIG. 4 is shown in a third configuration where a pocket module (designated with reference numeral “80b” in FIG. 4) is located in a lower or bottom portion of the SCPM. Accordingly, components of the SCPM 60b of FIG. 4 are configured in a third mode of operation to provide functionality of the Model CPM3 check processing module sold by NCR Corporation.

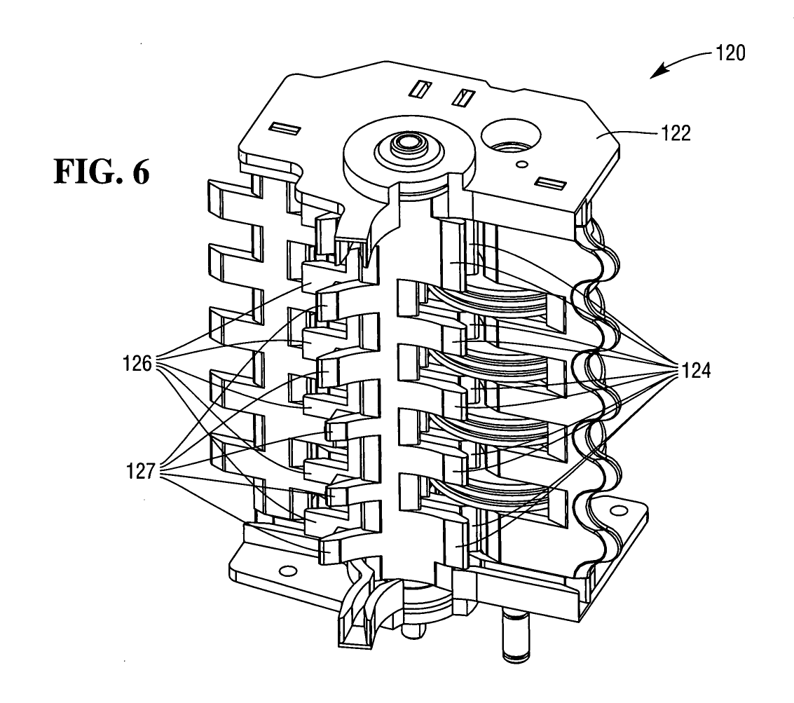

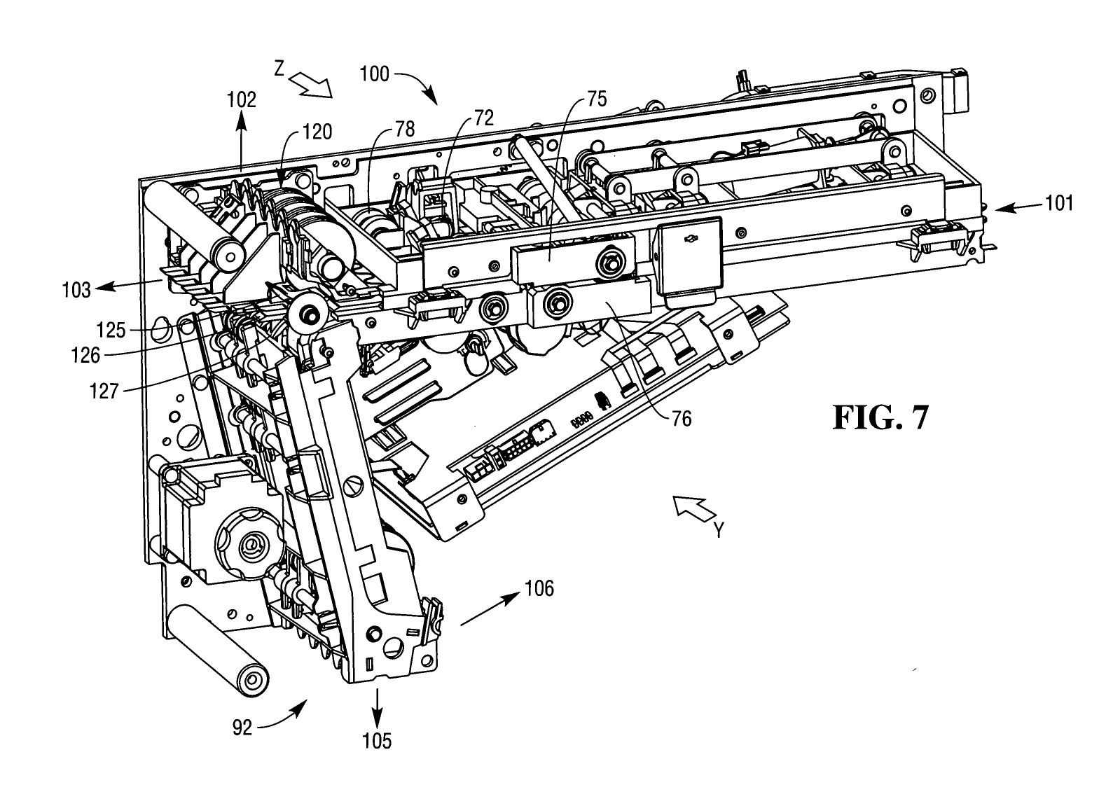

FIG. 6 is a pictorial view of the first diverter 120 in the form of a diverter blade. FIG. 7 is a view similar to the view of FIG. 5, and shows an end plate portion 122 (shown in FIGS. 5 and 6) removed for better viewing of the construction of parts of the first diverter 120. The first diverter 120 has a first plurality of fingers 124, a second plurality of fingers 125, (shown in FIG. 7), a third plurality of fingers 126, and a fourth plurality of fingers 127, for diverting documents such as checks in a manner to be described later.

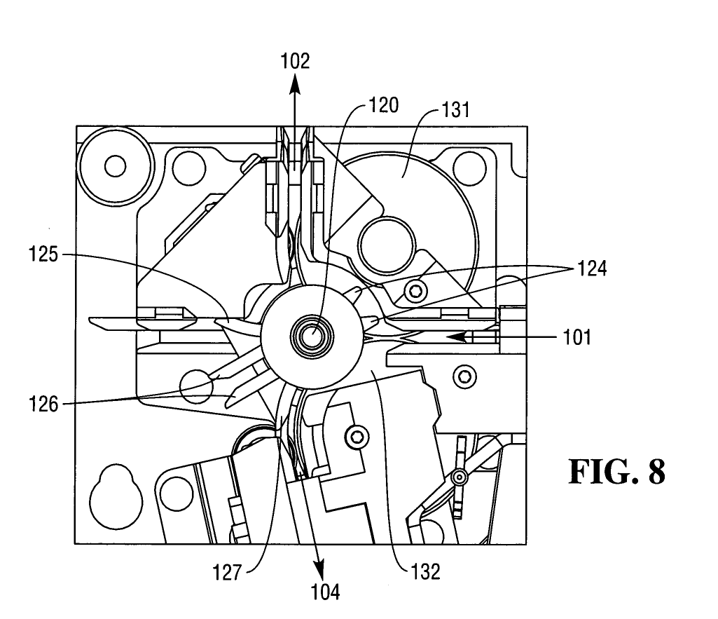

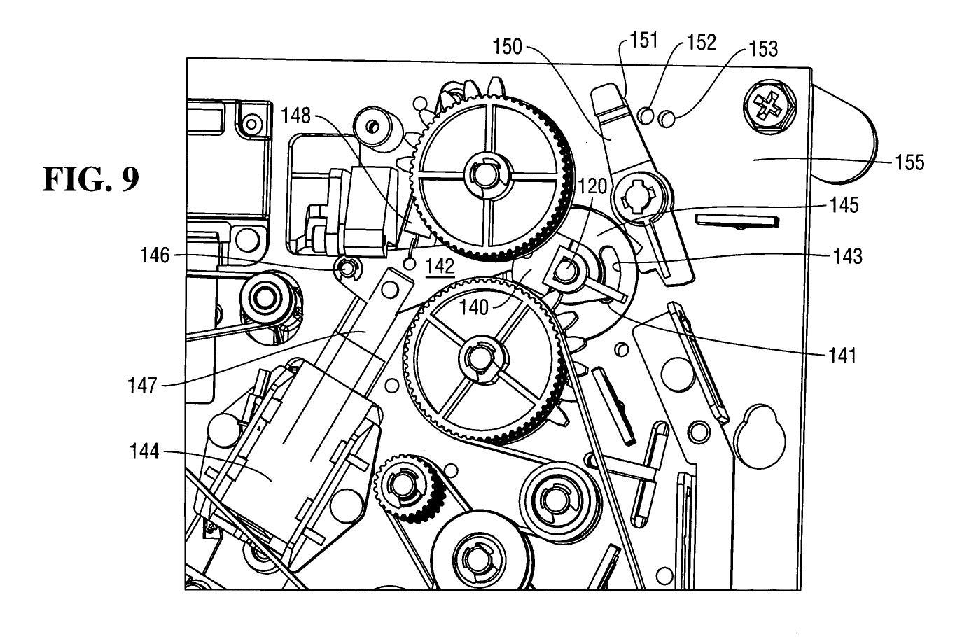

FIG. 8 is an elevational view, looking approximately in the direction of arrow Y shown in FIG. 7. FIG. 8 shows position of the first diverter 120 when parts are in a home position. FIG. 9 is an elevational view, looking approximately in the direction of arrow Z shown in FIG. 7. FIG. 9 shows position of parts of an actuator mechanism for the first diverter 120 when parts are in the home position of FIG. 8.

As shown in FIG. 8, a first drive roller 131 and a second drive roller 132 co-operate to transport a check along the first track portion 101 towards the first diverter 120. The first diverter 120 has the first, second, third, and fourth sets of fingers 124, 125, 126, 127. As shown in FIG. 9, the actuator mechanism for the first diverter 120 includes a diverter arm 140 which is coupled to a pivot plate 142. A pin 141 is connected to the diverter arm 140 and extends into a slot 143 of a base member 145. The extent of movement of the pin 141 is limited by the size of the slot 143.

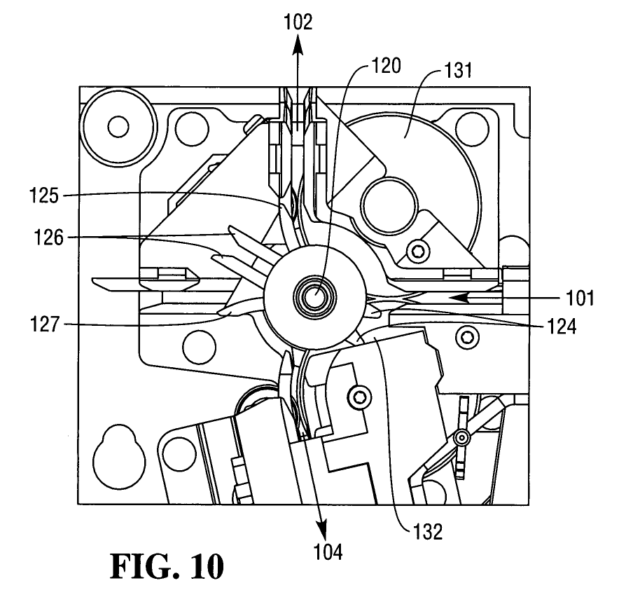

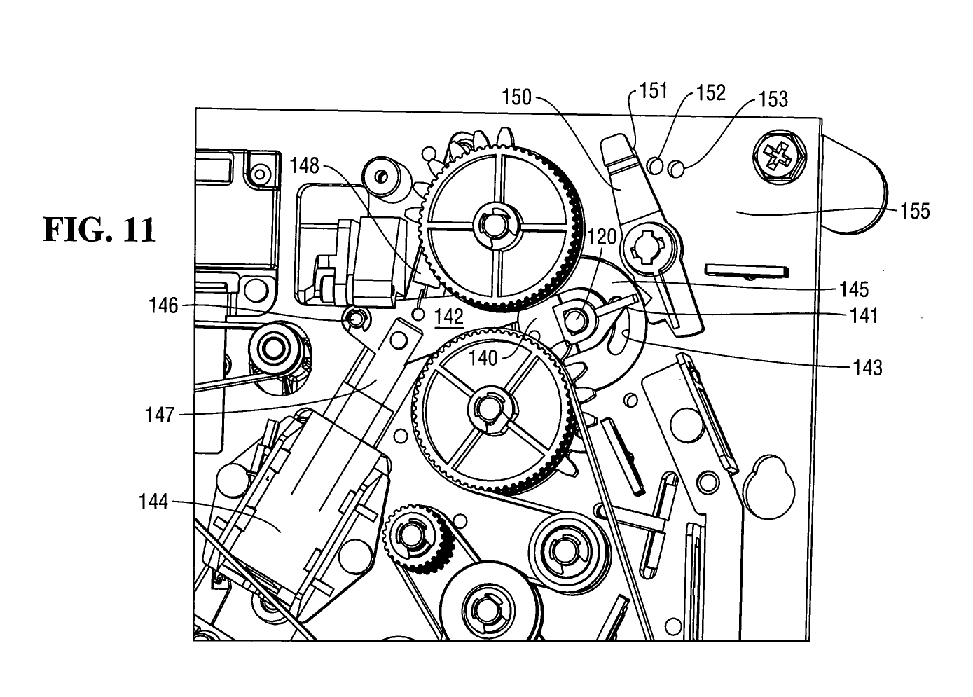

The pivot plate 142 is pivotable about a fixed shaft 146. An extension spring 148 is connected to the pivot plate 142 and provides a biasing force which acts through the pivot plate 142 and the diverter arm 140 to maintain parts in the home position shown in FIGS. 8 and 9. An actuatable solenoid 144 has an arm 147 which is connected to the pivot plate 142. When the solenoid 146 is actuated, parts move from the home position shown in FIGS. 8 and 9 to the position shown in FIGS. 10 and 11, respectively. When the solenoid 146 is deactuated, parts return from the position shown in FIGS. 10 and 11 back to the home position shown in FIGS. 8 and 9. Accordingly, in the first mode of operation of the SCPM 60 shown in FIG. 2, the first diverter 120 is movable between the home position (i.e., the solenoid is not actuated) shown in FIGS. 8 and 9 and the solenoid-actuated position shown in FIGS. 10 and 11.

When the SCPM 60 is in the first mode of operation as shown in FIG. 2, a detent arm 150 (FIGS. 9 and 11) is disposed in a first hole 151 in a base plate 155. The detent arm 150 can be disposed in a second hole 152 to configure the SCPM to operate in a second mode of operation which will be described later. Also, the detent arm 150 can be disposed in a third hold 153 to configure the SCPM to operate in a third mode of operation which will also be described later.

When the detent arm 150 is disposed in the first hole 151 as shown in FIGS. 9 and 11, the detent arm 150 is in a position which allows the pin 141 to move within the full extent of the slot 143 between the home position shown in FIG. 9 to the solenoid-actuated position shown in FIG. 11. Accordingly, when the SCPM 60 is configured to operate in the first mode of operation and the detent arm 150 is disposed in the first hole 151, a check can be transported from the first track portion 101 (see FIGS. 8 and 10) to either the fourth track portion 104 to the ERBM 90 when parts are in the home position shown in FIGS. 8 and 9 or the second track portion 102 to the pocket module 80 when parts are in the solenoid-actuated position shown in FIGS. 10 and 11.

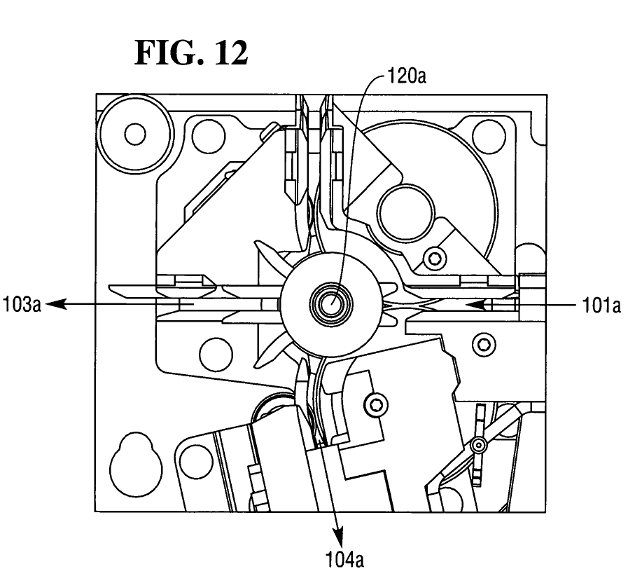

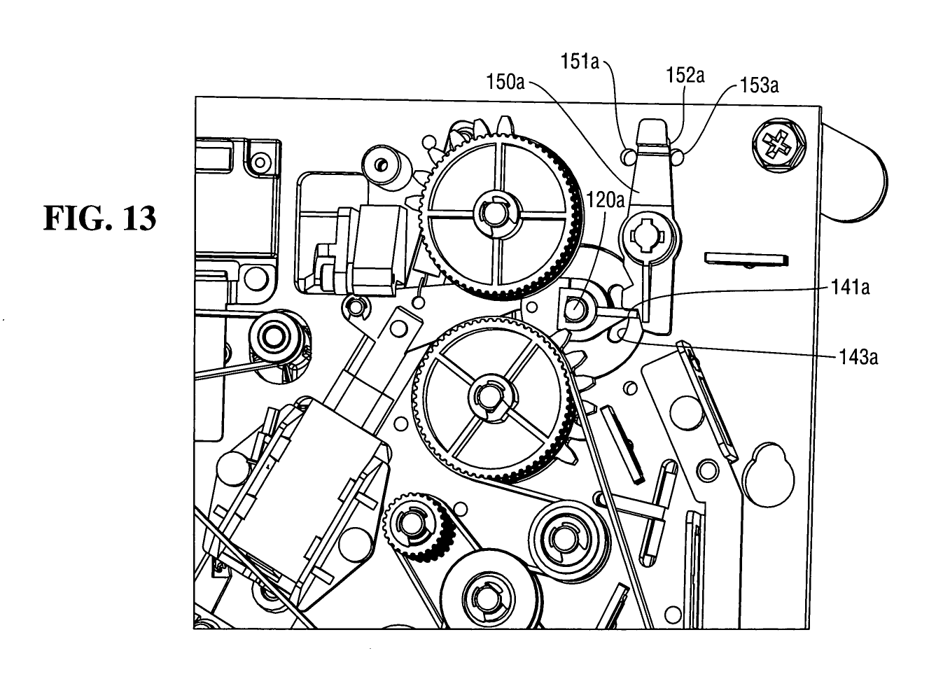

FIG. 12 is another elevational view, looking approximately in the direction of arrow Y shown in FIG. 7. FIG. 12 shows position of the first diverter 120a when the SCPM is configured to operate in the second mode of operation as shown in FIG. 3. FIG. 13 is another elevational view, looking approximately in the direction of arrow Z shown in FIG. 7. FIG. 13 shows position of parts of the actuator mechanism for the first diverter 120a when the SCPM 60a is configured to operate in the second mode of operation as shown in FIG. 3.

As shown in FIG. 13, the detent arm 150a is disposed in the second hole 152a. In FIG. 13, the detent arm 150a is in a position which allows the pin 141a to move within about half the extent of the slot 143a between the home position (not shown) and the solenoid-actuated position which is shown in FIGS. 12 and 13. The home position for when the SCPM 60a is configured to operate in the second mode of operation is similar to that shown in FIG. 9 just described hereinabove except that the detent arm 150a in FIG. 13 is in the second hole 152a instead of the first hole 151a or the third hole 153a. Accordingly, when the SCPM 60a is configured to operate in the second mode of operation as shown in FIG. 3 and the detent arm 150a is disposed in the second hole 152a as shown in FIG. 13, a check can be transported from the first track portion 101a (FIG. 12) to either the fourth track portion 104a to the second diverter 92a to the ERBM 90a when parts are in the home position (not shown) or the third track portion 103a to the pocket module 80a when parts are in the solenoid-actuated position shown in FIGS. 12 and 13.

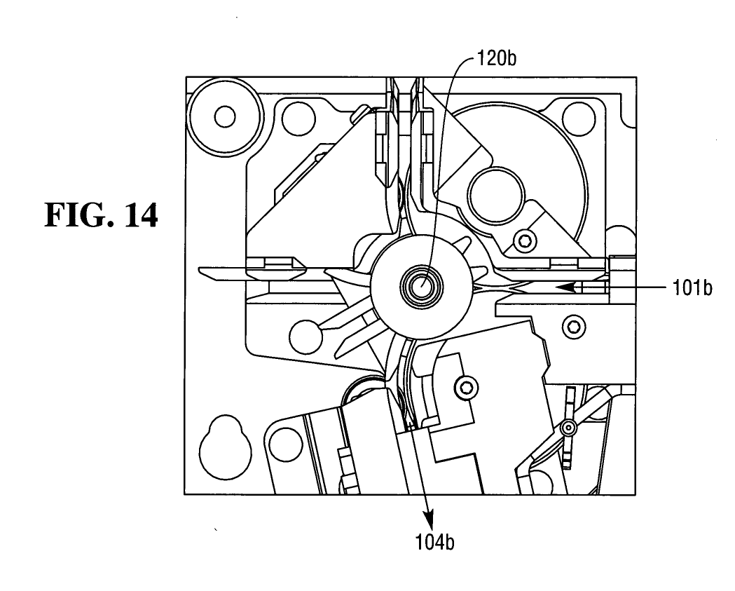

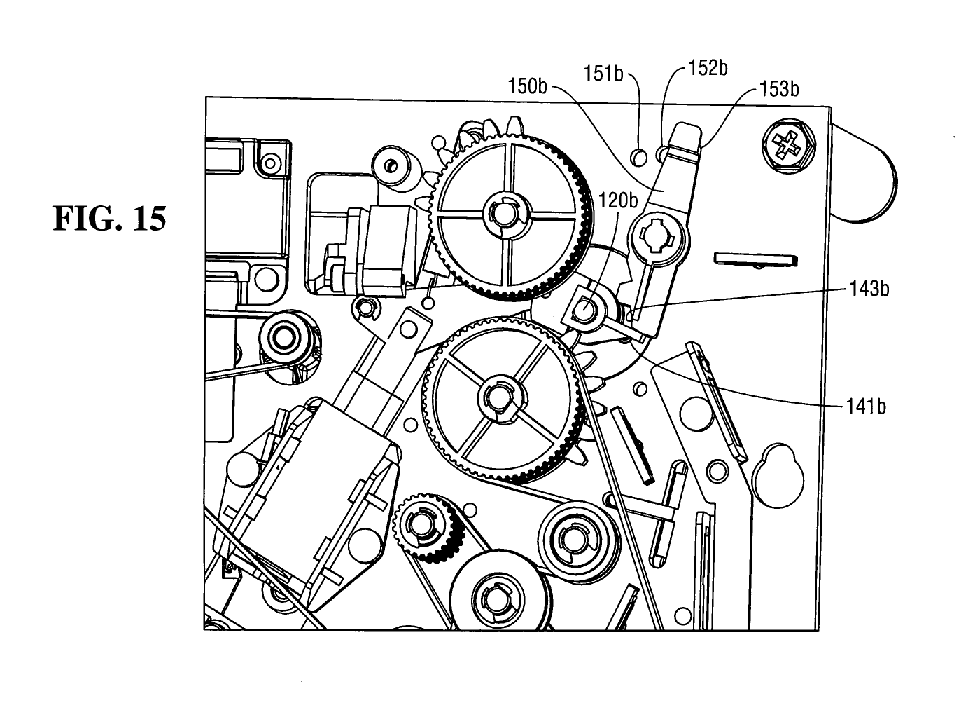

FIG. 14 is yet another elevational view, looking approximately in the direction of arrow Y shown in FIG. 7. FIG. 14 shows position of the first diverter 120b when the SCPM is configured to operate as shown in FIG. 4. FIG. 15 is yet another elevational view, looking approximately in the direction of arrow Z shown in FIG. 7. FIG. 15 shows position of parts of an actuator mechanism for the first diverter 120b when the SCPM is configured to operate in the third mode of operation as shown in FIG. 4.

As shown in FIG. 15, the detent arm 150b is disposed in the third hole 153b. In FIG. 15, the detent arm 150b is in a position which constrains the pin 141b in the slot 143b to remain substantially in the home position (not shown) and the solenoid-actuated position which is shown in FIGS. 14 and 15. The home position for when the SCPM 60b is configured to operate in the third mode of operation is similar to that shown in FIG. 9 just described hereinabove except that the detent arm 150b in FIG. 15 is in the third hole 153b instead of the first hole 151b or the second hole 152b. Accordingly, when the SCPM 60b is configured to operate in the third mode of operation as shown in FIG. 4 and the detent arm 150b is disposed in the third hole 153b as shown in FIG. 15, a check can be transported from the first track portion 101b along only the fourth track portion 104b to the second diverter 92b to the ERBM 90a whether parts are in the home position (not shown) or are in the solenoid-actuated position shown in FIGS. 14 and 15.

Although the above description describes checks being transported in a forward direction through the first diverter 120, 120a, 120b, it is conceivable that checks be transported in a reverse direction through the first diverter. The construction of the first, second, third, and fourth sets of fingers 124, 125, 126, 127 (best shown in FIGS. 6 and 7) is such that checks can be transported in directions which are opposite to those described hereinabove without having to be concerned about checks getting caught by the fingers and causing a document jam condition. Accordingly, the structure of the first diverter 120, 120a, 120b enables bidirectional flow of checks therethrough.

Although the above description describes the PERSONAS (trademark) 6676 NCR ATM embodying the present invention, it is conceivable that other models of ATMs, other types of ATMs, or other types of self-service check depositing terminals may embody the present invention. Self-service depositing terminals are generally public-access devices that are designed to allow a user to conduct a check deposit transaction in an unassisted manner and/or in an unattended environment. Self-service check depositing terminals typically include some form of tamper resistance so that they are inherently resilient.

Further, although the above description describes the SCPM 60, 60a, 60b which has the ERBM 90, 90a, 90b, it is conceivable that the present invention may be embodied in a SCPM which does not have an ERBM.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A document diverter apparatus for use in a check processing module (CPM) of a self-service check depositing terminal, the apparatus comprising:
a first member which can be (i) moved between a first position and a second position when the CPM is configured to operate in a first mode of operation, (ii) moved between the second position and a third position when the CPM is configured to operate in a second mode of operation, and (iii) constrained to be in the second position when the CPM is configured to operate in a third mode of operation; and
a second member Which can be (i) disposed in a first position to configure the CPM to be operate in the first mode of operation, (ii) disposed in a second position to configure the CPM to be operate in the second mode of operation, and (iii) disposed in a third position to configure the CPM to be operate in the third mode of operation.

2. An apparatus according to claim 1, wherein the first member comprises a diverter blade having a plurality of fingers.

3. An apparatus according to claim 1, wherein the second member comprises a detent arm which can be disposed in any one of the first, second, and third positions of the detent arm to configure the CPM in the first, second, and third modes of operation, respectively.

4. An apparatus according to claim 1, further comprising an actuatable solenoid for (i) moving the first member from the second position to the first position when the solenoid is actuated and the second member is disposed in the first position, and (ii) moving the first member from the second position to the third position when the solenoid is actuated and the second member is disposed in the second position.

5. A document diverter apparatus for use in a check processing module (CPM) of a self-service check depositing terminal, the apparatus comprising:
a diverter blade which can be (i) moved between a first position and a second position when the CPM is configured to operate in a first mode of operation, (ii) moved between the second position and a third position when the CPM is configured to operate in a second mode of operation, and (iii) constrained to be in the second position when the CPM is configured to operate in a third mode of operation;
a detent arm which can be (i) disposed in a first position to configure the CPM to be operate in the first mode of operation, (ii) disposed in a second position to configure the CPM to be operate in the second mode of operation, and (iii) disposed in a third position to configure the CPM to be operate in the third mode of operation; and
an actuatable solenoid for (i) moving the diverter blade from the second position to the first position when the solenoid is actuated and the detent arm is disposed in the first position, and (ii) moving the diverter blade from the second position to the third position when the solenoid is actuated and the detent arm is disposed in the second position for (i) moving the first member from the second position to the first position when the solenoid is actuated and the second member in disposed in the first position, and (ii) moving the first member from the second position to the third position when the solenoid is actuated and the second member in disposed in the second position.
